(19) United States
(12) Patent Application Publication
(10) Pub. No.: US 2007/0289460 A1
(43) Pub. Date: Dec. 20, 2007

(54) Single pass plastic card manufacturing system

(76) Inventor: Michael Tang, Monterey Park, CA (US)

Correspondence Address: CHRISTIE, PARKER & HALE, LLP, PO BOX 7068, PASADENA, CA, 91109-7068, US

(21) Appl. No.: 11/807,081

(22) Filed: May 24, 2007

Related U.S. Application Data
(60) Provisional application No. 60/808,832, filed on May 25, 2006.

(51) Int. Cl. B41F 5/16

(52) U.S. Cl. 101/181

(57) ABSTRACT

A system and method is provided for creating a fully formed printed card with a magnetically encoded strip in a continuous, single pass fashion. In one embodiment, a printing system includes a web flexographic press and an automated strip applicator and encoder. The web flexographic press receives a roll of thick card stock and has an unwinder that is adapted to unwind the roll of thick card stock into a continuous web. The automated strip applicator and encoder receives the web from the web flexographic press and lays and encodes a magnetic strip thereon. Here, the web has a thickness greater than 12 mils. In one embodiment, the thick card stock has a thickness ranging from 20 mils to 30 mils.

### CROSS-REFERENCE TO RELATED APPLICATION(S)

This application claims priority to and the benefit of U.S. Provisional Application No. 60/808,832, filed on May 25, 2006, the entire content of which is incorporated herein by reference.

### FIELD OF THE INVENTION

The present invention relates generally to high speed plastic card manufacturing systems and methods.

### BACKGROUND

Conventionally, thick plastic cards, such as those used as prepaid telephone cards, are manufactured using methods having a series of steps shown diagrammatically in FIG. 1. These steps ordinarily include initially printing text and graphics on a card, laying magnetic tape on the card, separating the card from its substrate, encoding the magnetic tape with information, and finally printing variable information on the card, such as a secret PIN number, as well as covering the PIN with a scratch-off foil material.

To accomplish these steps, typically flat sheets of card stock are processed though multiple separate machines. These flat sheets can only be made into a relatively small number of cards per sheet (ordinarily between 25 and 50) and must be moved by a human operator between separate machines throughout the printing process.

While it might seem more efficient to use rolls of plastic stock from which a greater number of cards may be made along with a conventional mechanically driven printing press in place of individual sheets and separate machines, this is not possible because of limitations of standard presses. Specifically, it is very difficult to align a card stock for the thick plastic cards and the print heads of the press to correctly print different colors on the same rolled card stock, for example, as part of a standard four-color printing process. Conventional mechanically driven printing presses simply do not have sufficient accuracy to properly align rolled card stock being printed in several passes in the same press. The stock will tend to stretch and flex within the press, causing different passes of the printing heads to occur either too early or too late. This problem of misalignment in the stock is compounded by the thicker plastic stock, which is preferred by customers for calling cards and similar applications. Furthermore, the inherent curvature of rolled stock further frustrates the smooth passage of the stock through the printing line.

As such, it is currently necessary to use flat sheets at least for the initial printing step so that they may be properly aligned with the printing heads during the initial printing step. Accordingly, a separate, stand-alone machine is typically used to register and initially print flat plastic sheets of stock material. Once initial printing is complete, a human processor takes the printed sheet and places it in a separate machine for application of the magnetic tape.

As is known in the prior art, separation of the individual cards from the substrate may be achieved using a die cutting process, wherein the cards are normally ejected through the base of the die cutting unit after which point the waste material is allowed to pass through the unit.

However, because it is difficult to collect the finished cards ejected from the die cutting unit in a manner which preserves the order in which they were originally produced in their substrates, and because prepaid telephone cards and the like are often designed to be shipped in numerically ordered lots, variable printing cannot be done on the cards before they are separated from their substrates. As such, once the completed cards from an individual sheet or group of sheets are separated and collected, they must be taken to a further processing equipment. This equipment then encodes variable or fixed data to the encoding tape if available. Another station then applies variable printing to the individual separated cards which then go to the labeling/foiling station to produce a finished product which may be shingled onto a conveyor to be collected and packaged in an orderly fashion.

All of these steps, multiple separate machines, and human interventions make processing thick plastic card stock currently very time consuming and expensive. However, because customers prefer thick plastic cards as a source of value (as opposed to paper cards or very thin plastic cards), the multi-step, machine, and human intervention manufacturing process is widely used today.

### SUMMARY

In an aspect of the invention, a system and method is provided for creating a fully formed printed card with a magnetically encoded strip in a continuous, single pass fashion.

In an embodiment, a printing system includes a web flexographic press programmed to receive a roll of thick card stock and an automated magnetic strip applicator and encoder receiving the roll of thick card stock from the web flexographic press and laying and encoding a magnetic strip thereon. The roll of thick card stock has a thickness greater than 12 mils. In one embodiment, the thick card stock has a thickness between 12 and 30 mils.

In one embodiment, the web flexographic press is a servo operated press, which performs four-color flexo printing on the roll of thick card stock. The printing system may also include a variable printing and foil applicator device, as well as a card separator.

In another embodiment, a printing system includes a web flexographic press and an automated strip applicator and encoder. The web flexographic press receives a roll of thick card stock and has an unwinder that is adapted to unwind the roll of thick card stock into a continuous web. The automated strip applicator and encoder receives the web from the web flexographic press and lays and encodes a magnetic strip thereon. Here, the web has a thickness greater than 12 mils.

In one embodiment, the thick card stock has a thickness ranging from 20 mils to 30 mils.

In one embodiment, the web flexographic press is a servo operated press adapted to perform five-color color flexo printing on the web.

In one embodiment, the printing system further includes a variable printing and foil applicator device adapted to receive the web from the automated strip applicator and to print a variable data thereon. The variable printing and foil applicator device may be further adapted to apply a scratchable foil over the variable data to obscure the variable data. The printing system may further include a card separator adapted to receive the web from the variable printing and foil applicator device and to separate the web into individual finished cards.

In one embodiment, the printing system further includes a card separator adapted to receive the web from the automated strip applicator and to separate the web into individual finished cards.

In one embodiment, the web flexographic press includes a plurality of forward print stations, wherein the forward print stations include a first print assembly, a second print assembly, a third print assembly, and a fourth print assembly, and wherein the first print assembly, the second print assembly, the third print assembly, and the fourth print assembly are serially connected to each other. The forward print stations may further include a laminating assembly coupled to apply a clear coating to the web output from the fourth print assembly. In one embodiment, the forward print stations include a fifth print assembly, and wherein the laminating assembly is coupled between the fourth assembly and the fifth assembly. Alternatively, the forward print stations may further include a fifth print assembly, and wherein the laminating assembly is coupled to apply the clear coating to the web output from the fifth print assembly.

In one embodiment, the flexographic press is adapted to apply a substantially constant torque to the thick card stock throughout the press to maintain a substantially constant tension to the continuous web.

In yet another embodiment, a printing system includes a web flexographic press adapted to receive a roll of thick card stock and having an unwinder adapted to unwind the roll of thick card stock into a continuous web and a variable printing and foil applicator device adapted to receive the web from the web flexographic press and to print a variable data thereon.

In one embodiment, the variable printing and foil applicator device is further adapted to apply a scratchable foil over the variable data to obscure the variable data.

In one embodiment, the printing system further includes a card separator adapted to receive the web from the variable printing and foil applicator device and to separate the web into individual finished cards.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 shows a block diagram detailing prior art printing methods;

FIG. 2a shows an in-line printing apparatus according to an exemplary embodiment of the present invention;

FIGS. 2b and 2c show a decuring station according to one embodiment of the present invention;

FIG. 2d shows an in-line printing apparatus according to another exemplary embodiment of the present invention;

FIG. 3 shows a section of card stock for use with the printing apparatus of FIG. 1;

FIGS. 4a, 4b and 4c show individual steps of a card separation process according to one embodiment of the present invention; and

FIG. 5 shows a card separation apparatus according to one embodiment of the present invention.

Before any embodiment of the invention is explained in detail, it is to be understood that the invention is not limited in its application to the details of construction and arrangements of components set forth in the following description, or illustrated in the drawings. The invention is capable of alternative embodiments and of being practiced or being carried out in various ways. For example, paper stock could be used in place of plastic stock with the apparatus as described herein. Also, it is to be understood that the terminology used herein is for the purpose of illustrative description and should not be regarded as limiting.

### DETAILED DESCRIPTION

In the following detailed description, certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive. There may be parts shown in the drawings, or parts not shown in the drawings, that are not discussed in the specification as they are not essential to a complete understanding of the invention. Like reference numerals designate like elements.

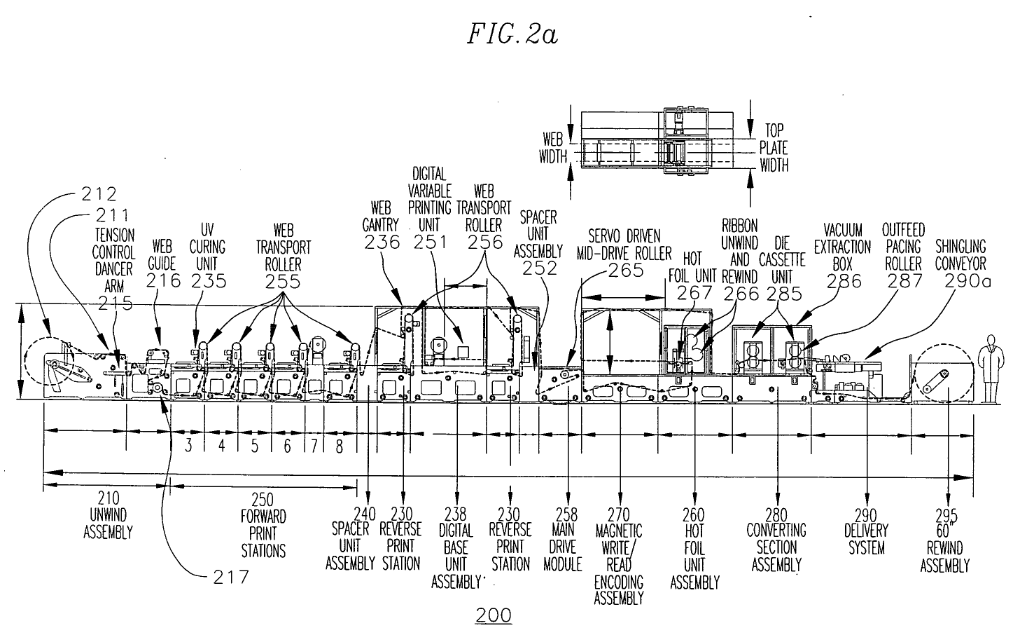

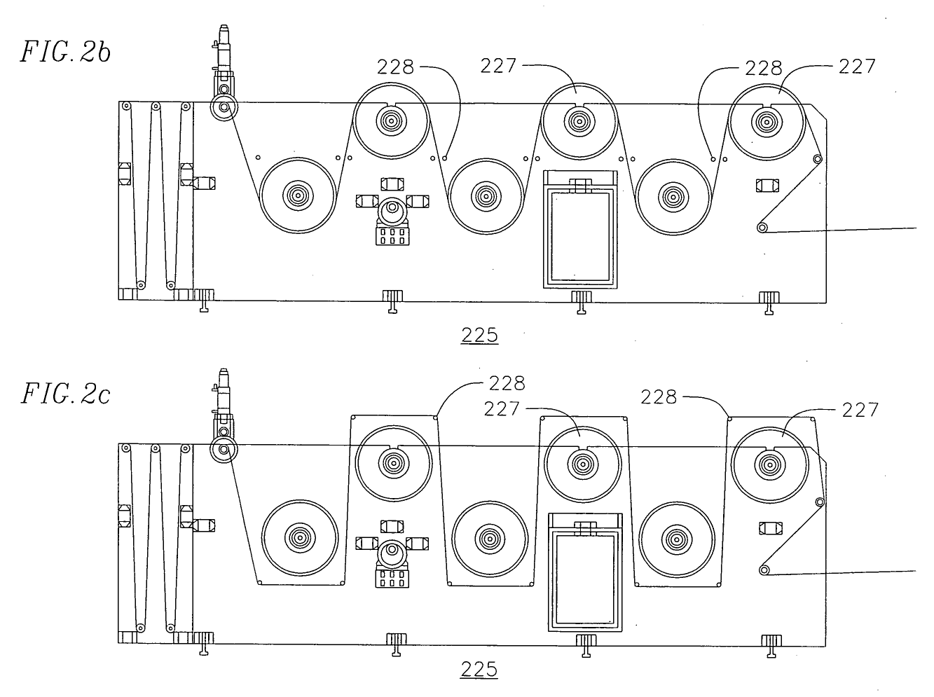

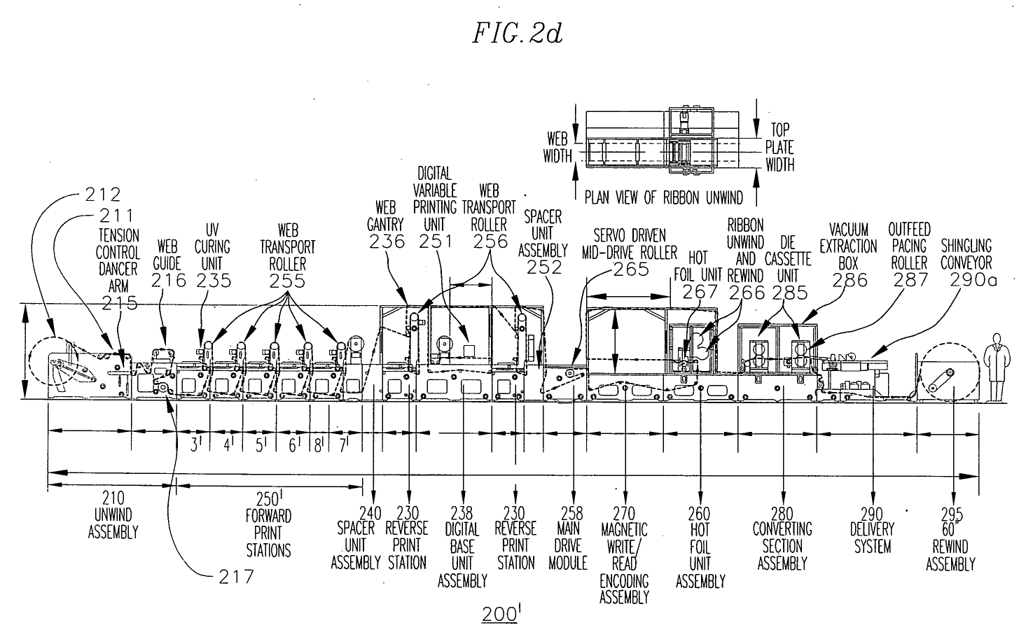

FIG. 2a shows an in-line printing apparatus according to an exemplary embodiment of the present invention. The printing line 200 of FIG. 2a features components arranged in a single horizontal plane. The printing line 200 is designed for in-line printing of relatively thick card stock and encoding of graphic, bar code, magnetic strip and other information, and is shown having components thereon for each of these purposes. In various embodiments, the printing line 200 shown in FIG. 2a may receive stock thicknesses ranging from 12 mils to 30 mils. The stock having a thickness of 12 mils can be an unsupported stock, and the stock having a thickness of 30 mils can be a plastic carton board. For the purposes of printing prepaid cards for retail sale, however, in a first alternative embodiment, the printing line 200 receives card stock thicknesses in the range from 20 mils to 30 mils. In yet another alternative embodiment, the printing line 200 receives card stock of over 15 mils in thickness. In a further alternative embodiment, the printing line 200 receives card stock of over 18 mils in thickness.

In an exemplary embodiment of the present invention, a programmable web flexographic packaging or “shaftless” press system is used. With such a system, large rolls of thick plastic stock substrate rather than smaller flat sheets may be processed rapidly and quickly in an in-line integrated printing system. As such, hundreds or thousands of thick plastic cards may be completely processed from start to finish using the present system in a single pass. Such a system has advantages in both cost (i.e., lower cost) and speed (i.e., higher speed) over traditional systems.

In a “shaftless” press, such as the one shown in FIG. 2a, components of the printing line 200 are driven directly using servos. As is known to one skilled in the art, a servo is a system for the automatic control of motion through feedback. The term servomechanism, or servo for short, can be used interchangeably with the feedback control system and represents a feedback loop in which the controlled quantity is a mechanical position or one of its derivatives.

Servos have several uses, including providing accurate motion control without the need for human attendants, accurately maintaining moving parts through mechanical load variations, controlling a high-power load from a low-power command signal, and controlling an output from a remotely located input. While these objectives might theoretically be attained by a nonfeedback system, if extremely accurate calibrated components were available, the self-calibration of a closed-loop feedback method permits economical design and production of accurate systems using primarily inaccurate components given that a typical servomechanism requires only a few of its components to have a high accuracy.

By using a web flexographic packaging press in the printing line 200, registration stability is achieved by precisely balancing each driven axis in the printing line 200 to ensure that a constant torque is applied to the card stock throughout the press. In one embodiment of the present invention, the printing line 200 uses multi-point closed loop tension control and has independent tension zones as well as digital servo drives on each driven axis. As such, an extremely constant web tension can be maintained throughout a range of speeds resulting in very accurate registration stability. Such registration stability is not possible with a mechanical or “shaft-driven” printing press.

Without this constant torque, parts of the card stock may be advanced or delayed along the printing line. This is especially problematic for multi-pass printing applications including four-color printing, because a portion of the card stock which is improperly advanced or delayed along the printing line will receive a portion of its graphic too early or too late, causing misalignment with graphics printed at other stations along the line.

Because a web flexographic packaging press allows rolled card stock to be used, it is no longer necessary to provide separate machines to perform each step of card manufacture. Steps including magnetic tape application and encoding, variable printing and foil application, and card die cutting and separation, which were all formerly performed separately on individual sheets or card stock, can now be performed on the same printing line 200 on different sections of the same continuous card stock. To this end, components have been added to the printing line 200 past the minimum required for simple four-color printing. These components will be described below in further detail in the context of FIG. 2a.

As shown in FIG. 2a, an unwinder 210 is situated at the beginning of the printing line 200 to receive a roll of continuous card stock (also referred to a roll of winded web) to unwind the roll of the continuous card stock (or web) and to unwind the continuous card stock (or web). Portions of the continuous card stock that has been unwinded are then held in a web holding unit 211. In one embodiment, this unwinder 210 includes a roller 212 that has a diameter of fifty inches and is provided with a roll lift. In a further embodiment, the unwinder 210 is additionally provided with a six and eight inch diameter air mandrel, a web guide 216, a servo driven infeed, a tension drum ten inches in diameter, and a closed loop tension controller.

In one embodiment, the printing line 200 features infeed and outfeed tension systems that are independently servo driven. In another embodiment, large diameter plasma coated rollers may be used to drive the continuous card stock. These drivers ensure total tension isolation between the tension zones for unwinding, printing, converting and rewinding the continuous card stock. In yet another embodiment, tension within the print zones is monitored via load cells, which in turn control the infeed drive. As a result, a constant tension is maintained throughout a range of speeds, regardless of the thickness or stiffness of the stock and its natural behavior in the printing line 200.

The continuous card stock (or web) passes through the unwinder 210 over a tension control dancer arm 215 (under the web holding unit 211). The tension control dancer arm 215 helps to maintain a constant tension in the card stock (or web). Further, along the printing line 200, the web guide 216 having an electronic sensor is provided. Below this, a tension drum 217 is placed, ten inches in diameter in this embodiment, which also helps to maintain a constant tension in the card stock.

Forward print stations 250 are then provided to print the initial graphics on the continuous card stock passing through the printing line 200. In one embodiment, the card stock undergoes at least four-color color flexo printing in the forward print stations 250 wherein graphics and text are printed onto the card stock. As shown in FIG. 2a, the card stock undergoes five-color color flexo printing in the forward print stations 250 using a first print assembly 3, a second print assembly 4, a third print assembly 5, a fourth print assembly 6, and a fifth print assembly 8.

In one embodiment, after one or more of the color flexo printing processes, a clear coating, preferably varnish, may be applied to the card stock using, for example, a laminating assembly 7 as shown in FIG. 2a. In FIG. 2a, the laminating assembly 7 is shown to be placed after the first, second, third, and fourth print assemblies 3, 4, 5, and 6 and before the fifth print assembly 8 of the forward print stations 250, so that one of the printing processes is made over the clear coating. In an alternative embodiment, the laminating assembly 7 (or another lamination assembly) can be moved (or positioned) to be after the first, second, third, fourth, and fifth print assemblies 3, 4, 5, 6, and 8, so that a clear coating can be applied after the entire color flexo printing processes have been performed. For example, FIG. 2d shows a printing line 200′ in which a laminating assembly 7′ is positioned after first, second, third, fourth, and fifth print assemblies 3′, 4′, 5′, 6′, and 8′ of forward print stations 250′, so that a clear coating can be applied after the entire color flexo printing processes have been performed.

Referring back to FIG. 2a, the forward print stations 250 are also provided with print cylinders, anilox rollers, and UV curing units 235 in the embodiment shown. In the embodiment shown in FIG. 2a, a “web-up” design is employed, wherein sections of the card stock to be dried post printing are raised on web transport rollers 255. Although FIG. 2a shows the UV curing units 235 being used as drying devices in the web-up portions of the printing line 200, it will be understood that in alternative embodiments, inks printed on the card stock by the forward printing stations 250 can be dried and/or cured using any combination of the following methods: infrared, re-circulating air and hot air, and/or UV with or without chilled rollers.

After the forward print stations 250, a spacer module (or spacer unit assembly) 240 is placed to enable reverse printing. The spacer module 240 is followed by two dedicated reverse print stations 230. The reverse print stations 230 incorporate print cylinders and may be fitted with a reverse angle doctor blade ink pan as well as UV drying devices. In one embodiment, the reverse print stations 230 may be fitted with a fully enclosed doctor blade as well as an ink pump for reverse printing.

Also, as shown in FIG. 2a, the reverse print stations 230 incorporate a web gantry 236 after the spacer module 240 to allow for a reverse print web path. The reverse print stations 230 include web transport rollers 256, which in the embodiment shown are servo driven devices eight inches in diameter. The reverse print stations 230 further include associated inking devices. After the reverse print stations 230, a second spacer module 252 is placed; and after the second spacer module 252, a servo driven mid-drive roller 265 is placed. The servo driven mid-drive roller 265 is used to form a main drive module 258. Also, in between the two dedicated reverse print stations 230 is a digital base unit assembly 238. The use of this digital base unit assembly 238 is to allow a self-adhesive laminating tape to be applied to the formed cards, if required by a customer, and/or to allow the printing line 200 to print personalized information and/or variable information or data (e.g., variable pin numbers, barcodes, serial numbers, instructions, advertisements, etc.) using a variable printing unit 251. In one embodiment, the variable printing unit 251 is a digital variable printing unit that can be remotely controlled by a variable print encoding computer. Also, in one embodiment, the variable printing unit 251 is a variable printing and foil applicator device adapted to print variable data, such as a secret PIN number, as well as to cover the variable data (e.g., the PIN number) with a scratch-off material (e.g., a scratch-off foil material).

In FIG. 2a, the main drive module 258 is placed on the output side of the reverse print stations 230. Like other drive modules throughout the printing line 200, the main drive module 258 may be provided as a servo driven unit, specifically, the eight inch diameter servo driven mid-drive roller 265 shown in FIG. 2a.

Further along the printing line 200, a magnetic write/read encoding assembly 270 and a die base and hot foil unit assembly 260 are placed to allow for the application of a magnetic strip to the cards being printed on the continuous card stock and to encode the magnetic strip. The die base and hot foil unit assembly 260 includes a hot foil unit 267, and an unwind and rewind unit 266. The magnetic write/read encoding assembly 270 may be equipped to encode up to three tracks of data in a single magnetic strip. The hot foil unit 267 is positioned in a converting cassette.

In one embodiment, a premanufactured strip of low or high coercivity magnetic media is unwound from a supply roll and is applied to the back of the card stock in the die base and hot foil unit assembly 260. The strip has an adhesive backing that is fixed to the card stock by a conventional hot stamp unit. One, two or three tracks of encoded data are written on the strip via the magnetic write/read encoding assembly 270. The data on the magnetic strip may be read for verification by the magnetic write/read head.

In one embodiment, the in-line magnetic card encoding performed in the magnetic write/read encoding assembly 270 is supported by a magnetic controller board, which supports single track encoding along the strip. Thus, the insertion of additional magnetic write/read encoding assemblies (or magnetic controller boards) allows simultaneous encoding of two (2) or three (3) tracks of card data along the strip. Furthermore, the magnetic controller board supports high and low coercivity magnetic media encoding by adding or removing a high current driver module and booster power supply. Further along the line, the magnetic write/read encoding assembly 270 may be provided and/or designed according to the user's specifications for locating an encoding system and/or an ink jet. In the embodiment shown, the magnetic write/read encoding assembly 270 is provide in a one and a half meter long cabinet.

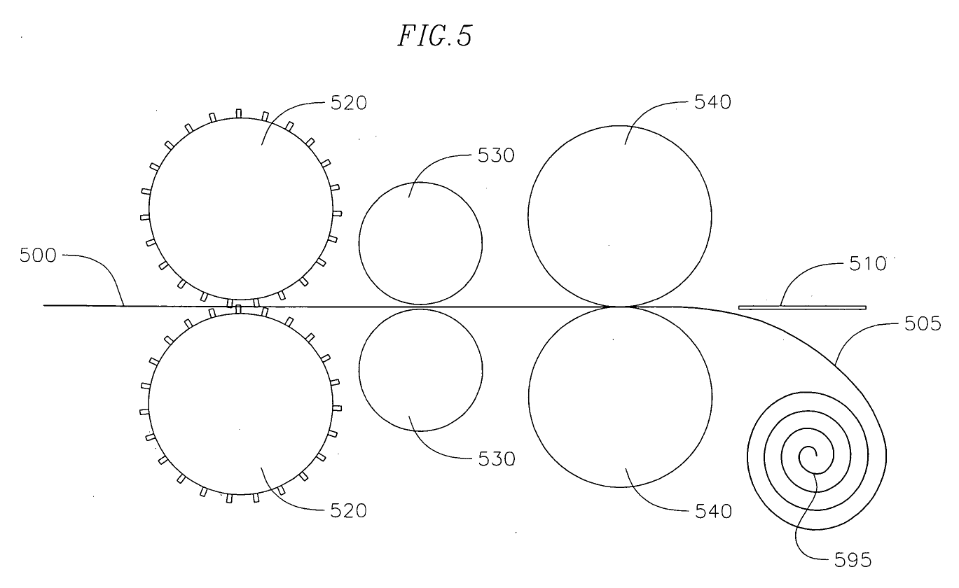

After this, a converting section assembly 280 is placed having two die base units (or die cassette units) 285 with two servo driven die cassettes as well as die pressure indicators. The maximum repeat for these cassettes is twenty four inches. The cassettes are used to die cut finish individual cards from the continuous card stock. A vacuum extraction box 286 is then used for the removal of any chaff produced by the die cutting process. In the embodiment shown, vacuum sources are not provided as part of the vacuum extraction box 286. The converting section assembly 280 also includes a servo driven outfeed pacing roller 287, which leads finished cards to a shingling conveyor 290a of a delivery system 290. Here, these cards are overlapped on a delivery conveyor belt for product collation. In addition, one embodiment of the above described card separation system (or die cutting part) is described in more detail below with reference to FIG. 5. However, the present invention is not thereby limited to the described embodiments. That is, in one embodiment of the present invention, the described die cutting part can be substituted with any suitable die cutting systems (e.g., a conventional die cutting system).

Finally, a rewinder (or a 60° rewind assembly) 295 is provided at the terminus of the printing line 200. In the embodiment shown, this rewind is forty inches in diameter and does not include a reel lift mechanism.

When a web of plastic card stock is provided on a roll, such as that which may be loaded onto the unwinder 210 of FIG. 2a, it may tend to form a set curvature over time. As such, when the card stock is unrolled and passed over the rollers of a printing line, it only partially elastically deforms while retaining internal stresses inducing it to deviate from the path formed by these rollers. This may cause problems in the processing of the card stock in the printing line.

To address this issue, in one embodiment of the present invention, a decuring station is provided as shown in FIGS. 2b and 2c. The decuring station may be included in the printing line 200 of FIG. 2a, and in an exemplary embodiment may be placed in position between the tension drum 217 and the first print assembly 3 of the forward print stations 250. The decuring station 225 is provided with heated rollers 227 and offset rollers 228. As is known to one skilled in the art, the heated rollers 227 may be used to remove internal stresses of the web allowing it to de-cure and plastically, rather than elastically, deform to more easily assume the shape imposed by the rollers and supports of the printing line. The offset rollers 228 may be selectively positioned from the positions shown in FIG. 2b to the positions shown in FIG. 2c, and be used to remove the web from contact with the heated rollers 227 when the web is stopped or moving slowly through the printing line, so that the heated rollers 227 do not overheat and damage the web.

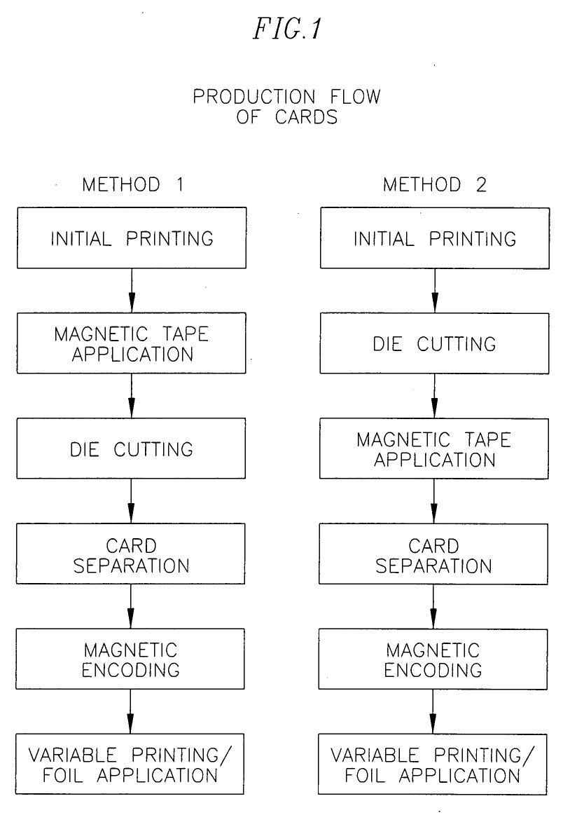

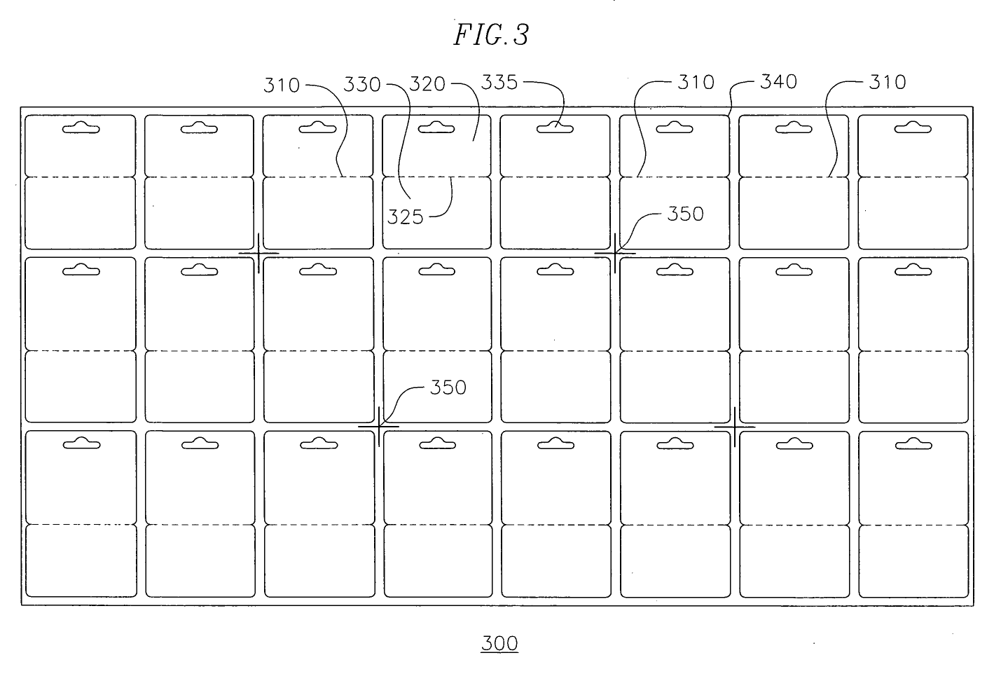

Turning now to FIG. 3, a section of card stock is shown for use with the printing apparatus of FIG. 1. The card stock 300 is formed as a continuous web, on which is shown multiple individual card footprints 310. These footprints 310 show outlines of completed card assemblies ready to be separated from the card stock 300. Each card assembly includes a display portion 320, an encoded portion 330, and a perforation 325 separating the two. In the exemplary embodiment shown, the display portion 320 may include advertising and promotional graphics, as well as a peg aperture 335 for mounting on a display rack. The peg aperture 335 may be formed through a die cutting process, as can the chamfered corners 340 shown at the periphery of the card footprints 310. After purchase of the card assembly by a customer, the encoded portion 330 may be removed along the perforation 325 from the display portion 320 and be used as, for example, prepaid telephone cards, while the latter may be discarded.

In one embodiment, start and stop synchronization of the printing line 200 is provided by an image synchronization controller. This subsystem provides card based delays that enable and disable printing and encoding for each device on the line. This is made possible given that while each card denoted by the individual card footprints 310 is part of the continuous card stock at the time of printing or encoding, it is in a discrete, pre-determined location on the continuous card stock. Effective synchronization can be accomplished by coordination between sensors that identify the preprinted mark 350 on the card stock. Synchronization control determines a precise location for a card based on the controlled speed of the card stock as it passes through the printing line 200 by identifying the edge of the card upon sensing the preprinted mark 350. Based on this information, an image synchronization controller provided as part of the printing line 200 signals a registration controller to delay or advance the card stock, so that it may be properly registered.

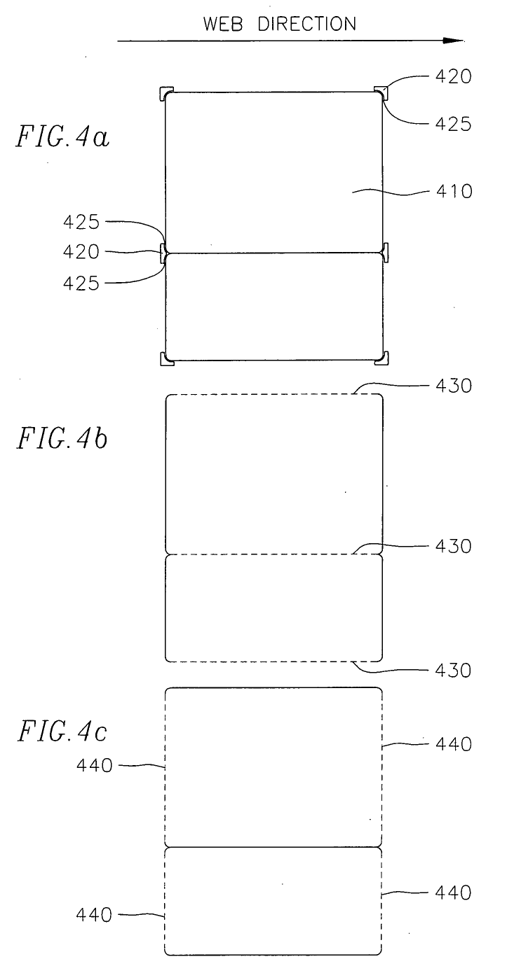

FIGS. 4a, 4b and 4c show an alternative embodiment of a card separation process combining die and bladed processes. In each of FIGS. 4a, 4b and 4c, a printable area 410 of a card assembly is shown. Around this printable area 410, reasonable margins are left to ensure the integrity of the graphics of the finished, separated card. Outside these margins, four preferably rounded die cut corners 425 and corner sections 420 are punched through the web of the card stock as shown in FIG. 4a. These corners 425 provide a chamfer on the edge of the finished card, which would be difficult to achieve with a linear bladed cut. Next, horizontal cuts 430 are made along the dashed lines as indicated in FIG. 4b in the direction of travel of the card stock using a rotary blade. These horizontal cuts 430 are preferably made in one continuous movement and must be closely registered to match one or more of the die cut corners 425 (e.g., a meeting point between two corresponding die cut corners 425). Finally, lateral (or vertical) cuts 440 are made along the dashed lines as shown in FIG. 4c to fully free the card from the web material. The lateral cuts 440 may be made by a chop blade to free the cards for collation.

FIG. 5 shows a card separation apparatus according to one embodiment of the present invention. In this apparatus, a card stock in the form of a continuous web 500 is fed through the device wherein it passes through the pairs of rollers 520, 530 and 540 as shown. The male-female die cutting rollers 520 are provided as a first set of rollers receiving the card stock 500, and are used to punch out an area of the card stock 500 to form the rounded die cut corners 425 as shown in FIGS. 4a-4c. As discussed above, ordinarily in a card stock die cutting process, two linearly moving die heads supported in a die base are used to make the corner sections 420 and the die cut corners 425 as shown in FIG. 4a, and the product is ejected from the bottom of the die base. However, in the embodiment shown, the die cutting rollers 520 are used to make a cut in a web of card stock which continues to pass down the printing line thereafter. The corner sections 420 which are die cut out of the web can be extracted from the female die using a vacuum roller as is known to one skilled in the art.

Next, the card stock passes through the horizontal cutting rollers 530, which make the horizontal cuts 430 as shown in FIGS. 4b and 4c, followed by the vertical cutting rollers 540 which make the lateral cuts 440 as shown in FIG. 4c. In one embodiment, these rollers 530 are scissor cutting rollers, which apply a shearing force to the card stock 500. Such rollers are preferable to a stamping or chopping method, wherein a cutting knife is pressed against card stock supported by a flat anvil. Such chopping methods can be unsuitable for thicker card stocks, specifically stock over 12 mil.

Once all the separation procedures have been performed by the rollers 520, 530 and 540, the waste stock web 505 is rolled onto a rewind 595, which, in the embodiment shown in FIG. 5, is placed below the horizontal level of the card stock 500. Because the die stamping and scissor cutting is performed in separate stages, and because the final lateral (or vertical) cut 440 is not performed for each card 510 until the card 510 is extending horizontally in a cantilever fashion from the waste stock web 505, which runs in a downward diagonal direction as it exits the card separation apparatus, it is a simple matter to shingle individual finished cards 510 onto a conveyer or other collection mechanisms, so that the finished cards 510 exit the card processing apparatus in order and are easily collected for packaging into numerically ordered lots. Thus, in one embodiment of the present invention, a shaftless web press system may be used together with a decuring apparatus and the card separation apparatus described herein, so that relatively thick card stock may be processed into numerically ordered lots of printed cards in a completely automated fashion in a single manufacturing line process.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A printing system comprising:
a web flexographic press adapted to receive a roll of thick card stock and having an unwinder adapted to unwind the roll of thick card stock into a continuous web; and
an automated strip applicator and encoder adapted to receive the web from the web flexographic press and to lay and encode a magnetic strip thereon,
wherein the web has a thickness greater than 12 mils.

2. The printing system of claim 1, wherein the web has a thickness ranging from 12 mils to 30 mils.

3. The printing system of claim 1, wherein the web has a thickness ranging from 20 mils to 30 mils.

4. The printing system of claim 1, wherein the web flexographic press is a servo operated press adapted to perform five-color color flexo printing on the web.

5. The printing system of claim 1, further comprising a variable printing and foil applicator device adapted to receive the web from the automated strip applicator and to print a variable data thereon.

6. The printing system of claim 5, wherein the variable printing and foil applicator device is further adapted to apply a scratchable foil over the variable data to obscure the variable data.

7. The printing system of claim 5, further comprising a card separator adapted to receive the web from the variable printing and foil applicator device and to separate the web into individual finished cards.

8. The printing system of claim 1, further comprising a card separator adapted to receive the web from the automated strip applicator and to separate the web into individual finished cards.

9. The printing system of claim 1, wherein the web flexographic press comprises a plurality of forward print stations, wherein the forward print stations comprise a first print assembly, a second print assembly, a third print assembly, and a fourth print assembly, and wherein the first print assembly, the second print assembly, the third print assembly, and the fourth print assembly are serially connected to each other.

10. The printing system of claim 8, wherein the forward print stations further comprise a laminating assembly coupled to apply a clear coating to the web output from the fourth print assembly.

11. The printing system of claim 9, wherein the forward print stations further comprise a fifth print assembly, and wherein the laminating assembly is coupled between the fourth assembly and the fifth assembly.

12. The printing system of claim 9, wherein the forward print stations further comprise a fifth print assembly, and wherein the laminating assembly is coupled to apply the clear coating to the web output from the fifth print assembly.

13. The printing system of claim 1, wherein the flexographic press is adapted to apply a substantially constant torque to the thick card stock throughout the press to maintain a substantially constant tension to the continuous web.

14. A printing system comprising:
means for receiving a roll of thick card stock and for unwinding the roll of thick card stock into a continuous web;
means for providing a multi-point closed loop tension control to perform at least four-color color flexo printing on the web; and
means for receiving the at least four-color flexo printed web from the web flexographic press and for automatically laying and encoding a magnetic strip thereon,
wherein the web has a thickness greater than 12 mils.

15. The printing system of claim 12, wherein the control means to perform the at least four-color color flexo printing on the web comprise means for performing at least five-color color flexo printing on the web.

16. The printing system of claim 12, further comprising means for receiving the magnetic stripped web and for printing a variable data thereon.

17. The printing system of claim 14, further comprising means for applying a scratchable foil over the variable data to obscure the variable data.

18. The printing system of claim 14, further comprising means for receiving the web having the printed variable data thereon and for separating the web into individual finished cards.

19. A printing system comprising:
a web flexographic press adapted to receive a roll of thick card stock and having an unwinder adapted to unwind the roll of thick card stock into a continuous web; and
a variable printing and foil applicator device adapted to receive the web from the web flexographic press and to print a variable data thereon,
wherein the web has a thickness greater than 12 mils.

20. The printing system of claim 19, wherein the variable printing and foil applicator device is further adapted to apply a scratchable foil over the variable data to obscure the variable data.

21. The printing system of claim 19, further comprising a card separator adapted to receive the web from the variable printing and foil applicator device and to separate the web into individual finished cards.
